(19) United States
(12) Patent Application Publication
(10) Pub. No.: US 2022/0343813 A1
(43) Pub. Date: Oct. 27, 2022

(54) MOBILE ADVERTISING DISPLAY APPARATUS

(71) Applicant: James Keith, III, Atlanta, GA (US)

(72) Inventor: James Keith, III, Atlanta, GA (US)

(21) Appl. No.: 17/240,166

(22) Filed: Apr. 26, 2021

(51) Int. Cl. G09F 13/04; G09F 7/20

(52) U.S. Cl. CPC G09F 13/0463; G09F 13/0456; G09F 13/0431; G09F 7/20; G09F 2007/1826

(57) ABSTRACT

Disclosed are various embodiments of a mobile advertising display apparatus. In one example, among others, the apparatus can include a display enclosure that includes a first side, a second side, a front side, and a back side. The first side can have a slot, and the back side can have an aperture that enables for a manipulation of content to be moved through the slot. The apparatus can include a flexible connector that has a first end and a second end. The first end can be attached to the back side of the display enclosure and a clamp can be attached to the second end of the flexible connector.

### BACKGROUND

Businesses seek to advertise products and services in high visibility locations and areas frequently visited by a target audience. In many cases, advertisements are limited in the areas in which they can be displayed because the advertisements are displayed in rigid structures that may be attached to a wall or some other structure. In other cases, advertisements may be attached to a wall in an unstable manner (e.g., via tape, adhesive, thumbtack, etc.). As such, there exists a need for a mobile advertising display that can be rigidly attached to a structure.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a front perspective view of a mobile advertising apparatus, according to one embodiment described herein.

FIG. 1B is an enlarged view of a display enclosure from FIG. 1A, according to one embodiment described herein.

FIG. 1C is a front perspective view of a display monitor for the mobile advertising apparatus, according to one embodiment described herein.

FIG. 2 is a side perspective view of the mobile advertising apparatus from FIG. 1, according to one embodiment described herein.

FIG. 3 is a back perspective view of the display enclosure from FIG. 1, according to one embodiment described herein.

FIGS. 4A and 4B illustrate multiple views of the mobile advertising apparatus attached to a urinal, according to one embodiment described herein.

### DETAILED DESCRIPTION

The embodiments of the present disclosure relate to a mobile advertising display apparatus. Businesses advertise products and services in high visibility locations and areas frequently visited by a target audience. In many cases, advertisements are limited in the areas in which they can be displayed because the advertisements are displayed in rigid structures that may be attached to a wall or some other structure. In other cases, advertisements may be attached to a wall in an unstable manner (e.g., via tape, adhesive, thumbtack, etc.). As such, the embodiments of the present disclosure are an improvement in the field because the embodiments can be attached to and removed from various structures.

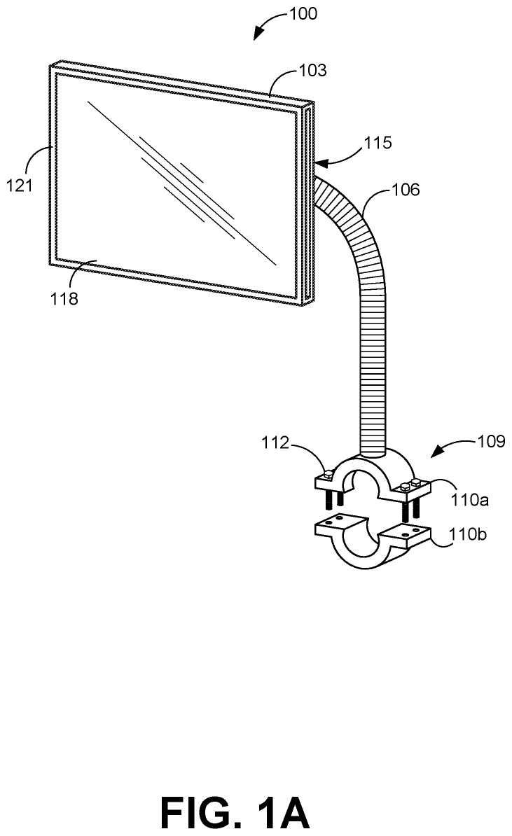

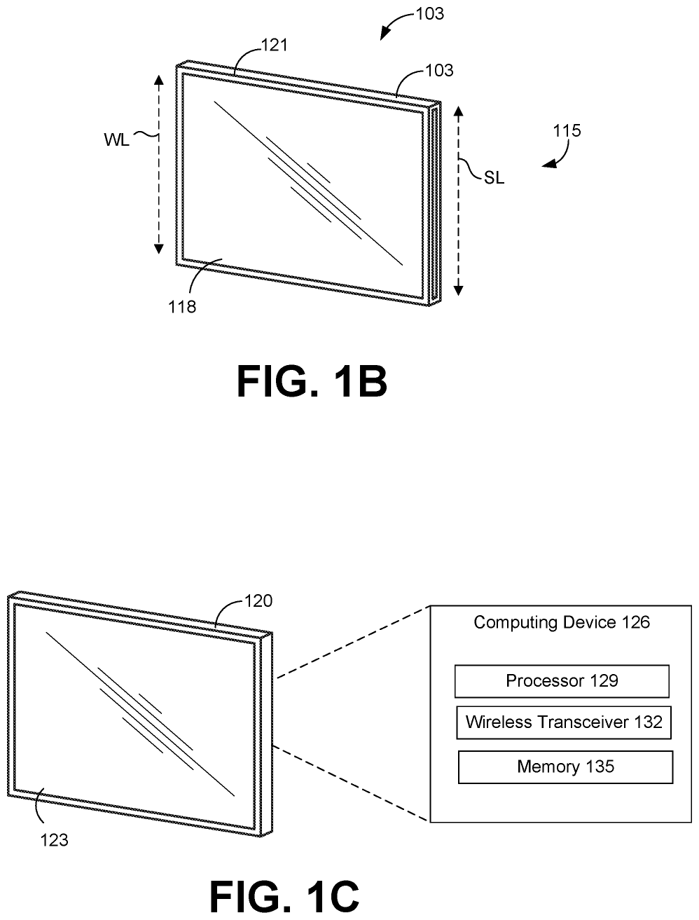

With reference to FIG. 1A, shown is a front perspective view of a mobile advertising display apparatus 100. The mobile advertising display apparatus 100 can be used to display content, such as a flyer or an advertisement. The mobile advertising display apparatus 100 can be attached to various structures, such as different pipes, walls, rails, and other structures. Additionally, the mobile advertising display apparatus 100 can be detached from a first structure, relocated to a different area, and attached to a second structure. The mobile advertising display apparatus 100 comprises a display enclosure 103, a flexible connector 106, an apparatus clamp 109, one or more fasteners 112, and other suitable components.

The display enclosure 103 can represent a structure receiving and displaying an advertisement. The display enclosure 103 can be configured in various shapes. As shown in FIG. 1, the display enclosure 103 has a rectangular shape. Additionally, the display enclosure 103 can include a first side, a second side, a front side, and a back side. The display enclosure 103 can include a slot 115 at the first side. The front side of the display enclosure 103 can include a viewing window 118. The viewing window 118 can be an area in which the flyer or advertisement can be viewed. The viewing window 118 can be an aperture in the display enclosure 103. In some embodiments, the viewing window 118 can include a transparent medium for preventing the content from falling out of the viewing window. At the same time, the transparent medium allows for the content to be viewable. Some non-limiting examples of a transparent medium can include a glass, plexiglass, plastic, polycarbonate, and other suitable transparent materials. The viewing window 118 can also include a perimeter frame 121 adjacent to the viewing window 118.

The flexible connector 106 can comprise a first end and a second end. At the first end, the flexible connector 106 can be attached to the display enclosure 103. At the second end, the flexible connector 106 can be attached to the clamp 109. The flexible connector 106 can be flexible in order to be manually manipulated in different arrangements. For example, the flexible connector 106 can be curved or bent in order to position the display enclosure 103 at a particular height or orientation. The flexible connector 106 can be a gooseneck connector, a flexible jointed metal pipe, or other suitable flexible connectors.

The clamp 109 can be used to attach the mobile advertising display apparatus 100 to various structures. For example, the clamp 109 can be attached to a pipe, a wall, or another available structure. As illustrated, the clamp 109 includes a first clamp head 110a and a second clamp head 110b (collectively “the clamp heads 110”). The clamp heads 110 can be attached to each other by one or more fasteners 112 (e.g., screws). In the illustrated example, a pipe, a rail, or other cylindrical shaped objects can be positioned between the clamp heads 110.

FIG. 1B illustrates an enlarged view of the display enclosure 103 from FIG. 1A. FIG. 1B includes a slot length “SL” for the slot 115 on the first side. FIG. 1B also includes a window length “WL” for the viewing window 118 at the second side of the display enclosure 103. In some embodiments, the slot 115 has a slot length “SL” that is substantially equal to the window length “WL.” In other embodiments, the slot length “SL” may be less than the window length “WL.”

FIG. 1C illustrates a display monitor 120 for the mobile advertising display apparatus 100. In some embodiments, the display enclosure 103 (FIGS. 1A and 1B) is replaced with the display monitor 120. As such, the display monitor 120 can be attached to the flexible connector 106. The display monitor 120 can be in data communication with a remote computing device via a network (e.g., WIFI, Internet, Bluetooth® protocol, etc.). The display monitor 120 can be configured to wirelessly receive and display content (e.g., advertisements). The display monitor 120 can include a display 123, a computing device 126, and other some suitable computing components. The computing device 126 can include a processor 129, a wireless transceiver 132, memory 135, and other suitable computing components. The wireless transceiver 132 can be used to receive content from a remote computing device via the Internet.

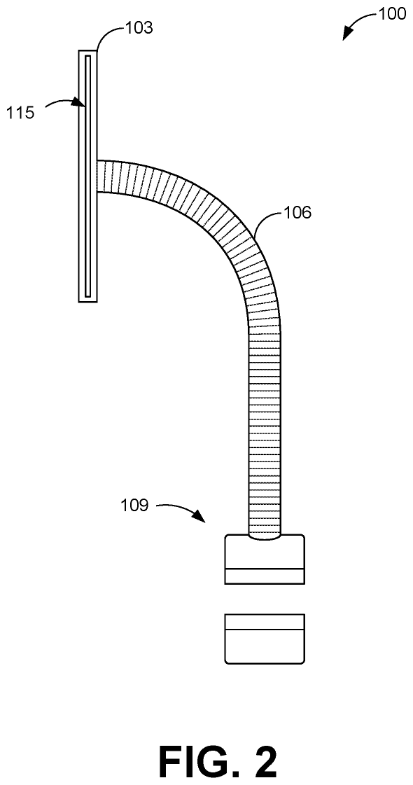

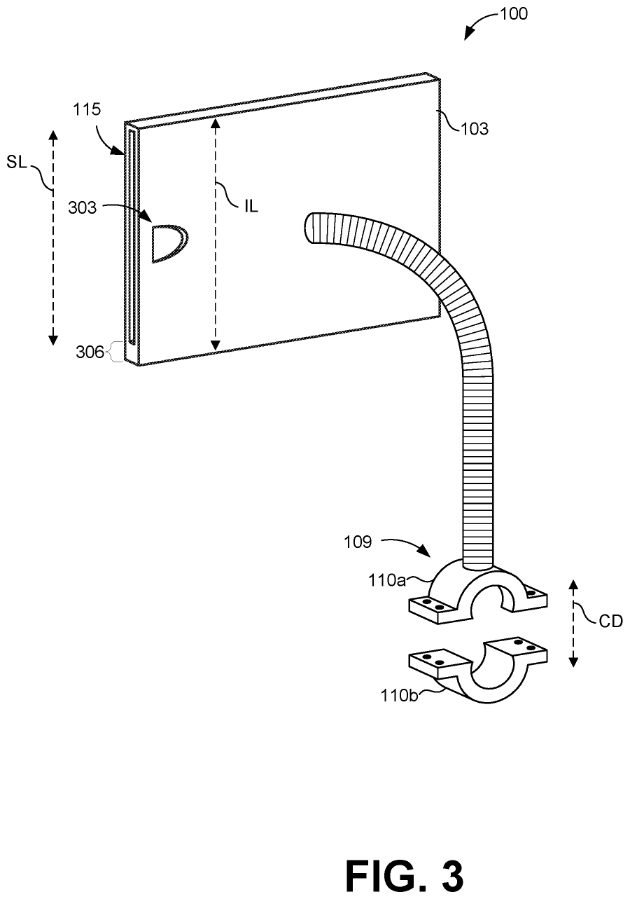

FIG. 2 illustrates a side perspective view of the mobile advertising display apparatus 100 from FIG. 1. Moving on, FIG. 3 illustrates a back perspective view of the mobile advertising display apparatus 100 from FIG. 1. As shown in FIG. 3, the display enclosure 103 can include an aperture 303 in the back side. As illustrated in the example, the aperture 303 has a shape of half an ellipse. The shape of the aperture 303 can vary. The aperture 303 allows for an individual to insert a finger or an object for manipulating the content inside the display enclosure 103. For example, the aperture 303 can be used to position content inside the display enclosure 103. Additionally, the aperture 303 can provide an individual access for removing the content (e.g., a flyer) from the slot 115. For example, the individual can insert a finger through the aperture 303 and move the content in a direction towards the slot 115.

In some embodiments, an individual may need to move the content in two directions in order to remove the content from the interior of the display enclosure 103. For example, the display enclosure 103 may have an interior length “IL” that is longer than the slot length “SL.” Adjacent to the slot 115 can be a ridge 306. As such, the individual may need to move the content a first direction toward the top of the display enclosure 103 in order to clear the ridge 306. Then, the individual may need to move the content in a second direction toward the slot 115. The ridge 306 may be constructed in order to prevent the content from sliding out of the display enclosure 103, particularly if the display enclosure 103 is angled toward the slot 115 side of the display enclosure 103.

Additionally, FIG. 3 illustrates a shape of the clamp 109. The clamp heads 110 form a circular opening when adjacent to each other. The circular opening can be used to receive a pipe, a rail, or other circular structures. The circular opening can have a clamp diameter “CD” that is a range between a half inch to three inches.

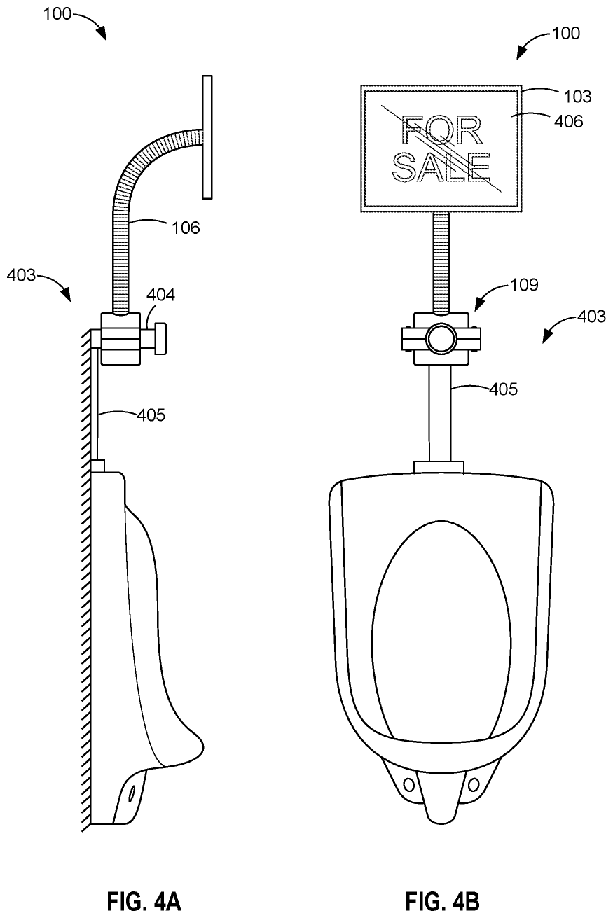

Moving to FIGS. 4A and 4B, shown are multiple views of the mobile advertising display apparatus 100 attached to a urinal 403. FIG. 4A illustrates a side view of the mobile advertising display apparatus 100 attached to the urinal 403, and FIG. 4B illustrates a front view of the mobile advertising display apparatus 100 attached to the urinal 403. FIG. 4B also illustrates a flyer 406 positioned inside of the display enclosure 103.

As shown in FIGS. 4A and 4B, the clamp 109 is attached to a portion of the pipe 404 for the urinal 403. The pipe 404 may be a tailpiece pipe, a supply pipe of the urinal 403, a flush value, a flush handle, and other suitable urinal fixture components. The pipe 404 is connected to a flush connection 405, which provides water to the basin of the urinal 403 during a flush. The mobile advertising display apparatus 100 can be removed and attached to a different location. For example, the mobile advertising display apparatus 100 can be attached to a flush connection 405, in which the clamp heads 110 are wrapped around the flush connection 405 pipe in an arrangement wherein the flush connection 405 is away from the wall. Additionally, in some embodiments, while attached to the urinal 403, the display enclosure 103 can be manipulated to various orientations because of the flexible connector 106. As another example, the mobile advertising display apparatus 100 can be attached to various locations inside of a restaurant, such as near a bar, a table, a rail, or other circular structures.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1.-17. (canceled)

18. A mobile advertising display apparatus, comprising:
a display monitor that comprises a display, a computing device, and a wireless transceiver;
a flexible connector that has a first end and a second end, the first end that attaches to a back side of the display monitor; and
a clamp that attaches to the second end of the flexible connector.

19. The apparatus of claim 18, wherein the flexible connector is an adjustable gooseneck connector.

20. The apparatus of claim 18, wherein the clamp comprises a pipe clamp.

21. The apparatus of claim 20, wherein the pipe clamp includes a fastener for securing and releasing the pipe clamp from a pipe structure.

22. The apparatus of claim 18, wherein the clamp comprises a first clamp head and a second clamp head, wherein the first clamp head is attached to the flexible connector.

23. The apparatus of claim 18, wherein the clamp comprises:
a first clamp head that includes a first curved interior surface; and
a second clamp head that includes a second curved interior surface.

24. The apparatus of claim 23, wherein the first clamp head comprises a curved surface that attaches to the flexible connector.

25. The apparatus of claim 23, wherein the first clamp head and the second clamp head comprise a corresponding pair of fastener apertures, wherein the corresponding pair of fastener apertures are configured to receive a fastener.

26. The apparatus of claim 18, wherein the clamp is configured to be attached to a pipe in a diameter range between a half inch to three inches.

27. The apparatus of claim 18, wherein the flexible connector is a flexible jointed metal pipe.

28. The apparatus of claim 18, further comprising:
a urinal that comprises a pipe for water supply, wherein the clamp of the positioned around the pipe.

29. The apparatus of claim 28, wherein the pipe is at least one of a flush connection, a water supply pipe, or a tailpiece pipe.

30. The apparatus of claim 28, wherein the computing device is configured to at least:
receive, via the wireless transceiver, receive content from a remote computing device over a network; and
present, via the display, the content in the display monitor.

31. The apparatus of claim 30, wherein the network is a Bluetooth protocol.
